(19) United States
(12) Patent Application Publication
(10) Pub. No.: US 2026/0140365 A1
(43) Pub. Date: May 21, 2026

(54) ELECTRONIC DEVICE INSTALLED ON VEHICLE WITH WINDSHIELD

(71) Applicants: Innolux Corporation, Miaoli County (TW); CARUX TECHNOLOGY PTE. LTD., SINGAPORE (SG)

(72) Inventors: Yu-Chia Huang, Miaoli County (TW); Ching-I Lo, Tainan (TW); Tsung-Han Tsai, Miaoli County (TW); Li-Wei Sung, Tainan (TW)

(73) Assignees: Innolux Corporation, Miaoli County (TW); CARUX TECHNOLOGY PTE. LTD., SINGAPORE (SG)

(21) Appl. No.: 19/359,718

(22) Filed: Oct. 16, 2025

(30) Foreign Application Priority Data
Nov. 21, 2024 (CN) 202411675486.9

(51) Int. Cl. G02B 27/00; B60K 35/231; G02B 27/01

(52) U.S. Cl. CPC G02B 27/0006; B60K 35/231; G02B 27/0101; G02B 27/0149; G02B 2027/0154

(57) ABSTRACT

An electronic device installed on a vehicle with a windshield includes a display module, a cleaning module, and a dust collection module. The display module includes a light-emitting unit and a cover layer. The light-emitting unit is adapted to emit a light beam. The cover layer is disposed on the light-emitting unit and overlaps the light-emitting unit. The windshield is opposite to the display module. The light beam penetrates the cover layer and is incident on the windshield, allowing the human eye to observe a virtual image formed behind the windshield. The cleaning module and the dust collection module are disposed on two opposite sides of the display module. At least a portion of the cleaning module is adjacent to the cover layer, the dust collection module has an opening, and the opening is adjacent to the cover layer.

### CROSS-REFERENCE TO RELATED APPLICATION

This application claims the priority benefit of China application serial no. 202411675486.9, filed on Nov. 21, 2024. The entirety of the above-mentioned patent application is hereby incorporated by reference herein and made a part of this specification.

### BACKGROUND

Panoramic head up displays (PHUDs) are the future trend. However, due to the placement limitations of the panoramic head up displays (such as horizontal placement rather than upright placement), dust accumulation is likely to occur, resulting in a decrease in display quality. In addition, since the panoramic head up display is located far away from the user, it is difficult to wipe it manually. Therefore, how to effectively clean the panoramic head up displays to address the dust problem has become one of the issues that need to be solved urgently.

### BRIEF DESCRIPTION OF THE DRAWINGS

FIG. 1A is a schematic view of a relative position of an electronic device and a windshield according to an embodiment of the disclosure.

FIG. 1B is a schematic view of the electronic device of FIG. 1A.

FIG. 1C is a schematic view of the electronic device in FIG. 1A from another viewing angle.

FIG. 2A is a schematic top view of an electronic device according to another embodiment of the disclosure.

FIG. 2B is a schematic cross-sectional view along line I-I of FIG. 2A.

FIG. 2C is a schematic view of a dust collection module of an electronic device according to another embodiment of the disclosure.

FIG. 3A is a schematic top view of an electronic device according to another embodiment of the disclosure.

FIG. 3B is an enlarged schematic view of a cleaning module of the electronic device in FIG. 3A at another viewing angle.

FIG. 4A is a schematic top view of an electronic device according to another embodiment of the disclosure.

FIG. 4B is an enlarged schematic view of a cleaning module of the electronic device in FIG. 4A at another viewing angle.

FIG. 5 is a schematic top view of an electronic device according to another embodiment of the disclosure.

FIG. 6 is a flow chart of a cleaning procedure of an electronic device according to an embodiment of the disclosure.

FIG. 7 is a system configuration view of the electronic device of FIG. 6.

### DESCRIPTION OF THE EMBODIMENTS

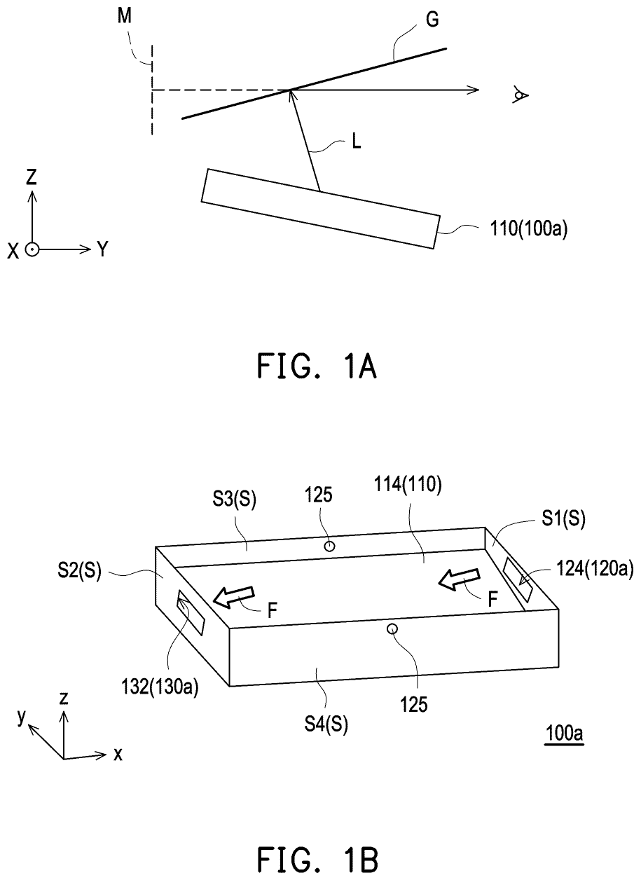

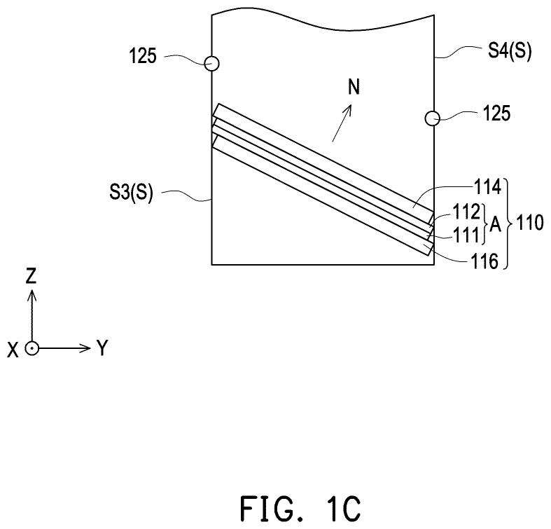

FIG. 1A is a schematic view of a relative position of an electronic device and a windshield according to an embodiment of the disclosure. FIG. 1B is a schematic view of the electronic device of FIG. 1A. FIG. 1C is a schematic view of the electronic device in FIG. 1A from another viewing angle.

With reference to FIG. 1A, FIG. 1B, and FIG. 1C together, an electronic device 100a installed on a vehicle with a windshield G includes a display module 110, a cleaning module 120a, and a dust collection module 130a. The display module 110 includes a light-emitting unit 112 and a cover layer 114. The light-emitting unit 112 is adapted to emit a light beam L. The cover layer 114 is disposed on the light-emitting unit 112 and overlaps the light-emitting unit 112. The windshield G is opposite to the display module 110. The light beam L penetrates the cover layer 114 and forms an image M on the windshield G. The cleaning module 120a and the dust collection module 130a are disposed on opposite sides of the display module 110. At least a portion of the cleaning module 120a is adjacent to the cover layer 114, the dust collection module 130a has an opening 132, and the opening 132 is adjacent to the cover layer 114.

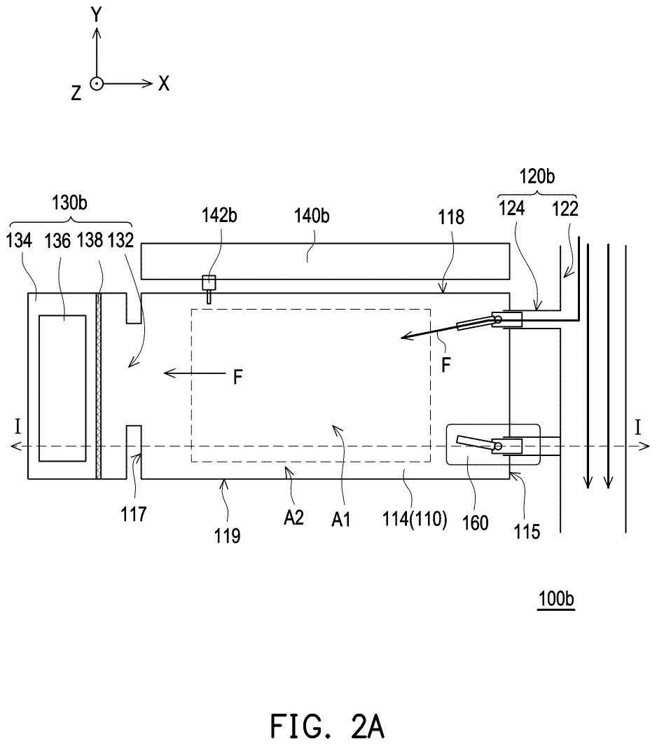

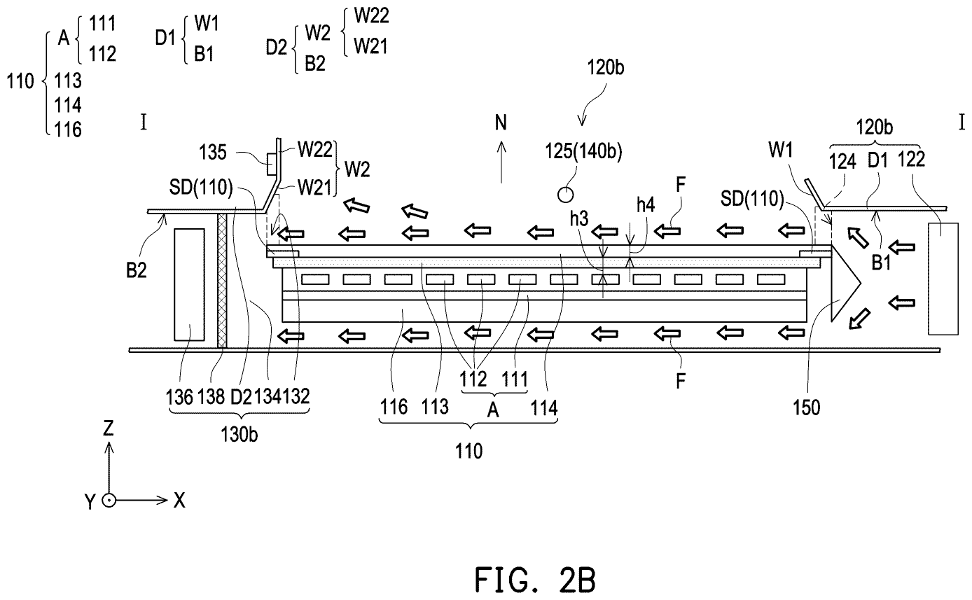

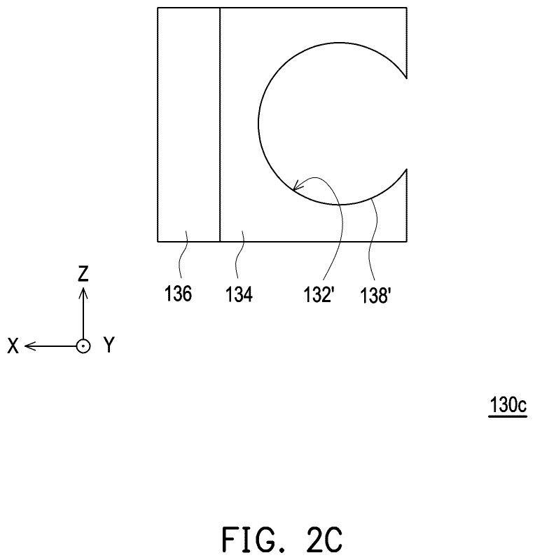

To be specific, the vehicle with the windshield G may be, for example, a car, and the electronic device 100a may be installed in a vehicle such as a car, a ship, or an airplane for passengers or drivers to use, but the disclosure is not limited thereto. The display module 110 is disposed in a storage groove S, where the storage groove S has a first side S1 and a second side S2 opposite to each other as well as a third side S3 and a fourth side S4 connected to the first side S1 and the second side S2 and opposite to each other. The cleaning module 120a and the dust collection module 130a are disposed on the first side S1 and the second side S2 of the storage groove S respectively. In an embodiment, a display apparatus A (as shown in FIG. 2B) in the display module 110 may be a non-self light-emitting display device, for example, a liquid crystal display or a quantum dots light-emitting diode (LED) display. In an embodiment, the display apparatus A in the display module 110 may also be a self light-emitting display module, for example, a LED display or an organic LED display.

Further, the display apparatus A in the display module 110 includes a plurality of light-emitting units 112 (as shown in FIG. 2B). The plural light-emitting units 112 may be, for example, LED chips or organic light-emitting layers, but the disclosure is not limited thereto. As shown in FIG. 1C, the cover layer 114 and the light-emitting unit 112 of this embodiment overlap each other in a normal direction N of the display module 110. Further, the display apparatus A of this embodiment also includes a substrate 111, where the substrate 111 and the cover layer 114 are parallel to each other. The substrate 111 may be, for example, a substrate with active components and passive components, but the disclosure is not limited thereto. In another embodiment, the display module 110 also includes a heat dissipation plate 116 disposed under the substrate 111 of the display apparatus A, but the disclosure is not limited thereto. With reference to FIG. 1A and FIG. 1C again, the windshield G and the display module 110 are opposite to each other, where an angle is provided between the windshield G and the display module 110. The light beam L emitted by the light-emitting unit 112 in the display module 110 penetrates the cover layer 114 and is projected onto the windshield G, allowing the human eye to observe the image M formed behind the windshield G. In other words, the light beam L penetrates the cover layer 114 and is incident on the windshield G, allowing the human eye to observe the image M formed behind the windshield G. Herein, the image M is a virtual image, for example. The aforementioned “an angle is provided between the windshield G and the display module 110” means that the display module 110 is placed at an angle, so that an outline shape of the virtual image M is roughly consistent with an outline of a light-emitting region A1 of the display module 110 and may reduce the problem of distortion of the virtual image M. In this embodiment, the image M is formed on the windshield G, but the disclosure is not limited thereto. In an embodiment, the image M may be formed on a transparent layer, a semi-transparent layer, a car window, glass, an acrylic board, or a suitable imaging layer.

Next, with reference to FIG. 1B again, in this embodiment, the cleaning module 120a may be, for example, an air blowing device. An airflow F blown out by the cleaning module 120a flows over a surface of the cover layer 114 of the display module 110, to blow the dirt (such as dust, etc.) on the surface of the cover layer 114 to the opening 132 of the dust collection module 130a disposed on the opposite side of the cleaning module 120a, and the opening 132 collects the dirt (such as dust, etc.) into the dust collection module 130a by means of air extraction. In other words, in this embodiment, the surface of the display module 110 is cleaned through a non-contact cleaning module 120a. More specifically, the air source of the cleaning module 120a may come from an independent fan system or the air conditioning system in the vehicle, but the disclosure is not limited thereto. In this embodiment, at least a portion of the cleaning module 120a adjacent to the cover layer 114 means that the air outlet of the cleaning module 120a is adjacent to the cover layer 114, to facilitate the airflow F blown out by the cleaning module 120a to remove the dirt on the surface of the cover layer 114. In an embodiment, the air outlet of the cleaning module 120a may be a long opening. In an embodiment, the air outlet of the cleaning module 120a may be arranged in a row of multiple separate openings, where the air volume blown out of small openings is smaller, and the air extraction volume of the opening 132 of the dust collection module 130a may be larger when extracting air, thereby suppressing dust dispersion.

In addition, with reference to FIG. 1B and FIG. 1C together, in this embodiment, the cleaning module 120a may also include a detection component 125. The detection component 125 may be disposed on the third side S3 or/and the fourth side S4 of the storage groove S to detect the degree and type of dirt (such as dust or oil stains, etc.) on the surface of the cover layer 114. After detection, the cleaning module 120a may selectively execute corresponding cleaning methods for different types of dirt. For instance, air blowing cleaning may be used for dust, and wiping cleaning may be used for oil stains. In an embodiment, the detection component 125 may be, for example, infrared detection, visible light detection, haze detection, electrical detection (capacitance or resistance), but the disclosure is not limited thereto. In an embodiment, the air outlet 124 of the cleaning module 120a may be disposed on any side of the storage groove S, and the opening 132 of the dust collection module 130a is disposed on the opposite side of the cleaning module 120a, that is, the air outlet 124 of the cleaning module 120a and the opening 132 of the dust collection module 130a are disposed on opposite sides of the display module 110. In an embodiment, the air outlet 124 of the cleaning module 120a may be disposed on multiple sides of the storage groove S, while the opening 132 of the dust collection module 130a is disposed on one of the remaining sides of the storage groove S. In non-rectangular display modules, the opposite arrangement of the air outlet 124 and the opening 132 may increase the smoothness of the airflow F from being blown out of the air outlet 124 to being sucked into the opening 132, and cleaning efficiency may thus be improved.

In brief, in this embodiment, the electronic device 100a includes the cleaning module 120a and the dust collection module 130a arranged on opposite sides of the display module 110, where the air outlet of the cleaning module 120a is adjacent to the cover layer 114, and the opening 132 of the dust collection module 130a is adjacent to the cover layer 114. Through this design, the non-contact cleaning module 120a may clean the dirt (such as dust, etc.) on the surface of the display module 110 and collect it into the dust collection module 130a, so that the impact of dirt on the display quality of the electronic device 100a may be reduced/avoided. In addition, the cleaning module 120a of this embodiment also includes the detection component 125, which may detect the degree of and type of dirt.

FIG. 2A is a schematic top view of an electronic device according to another embodiment of the disclosure. FIG. 2B is a schematic cross-sectional view along line I-I of FIG. 2A. With reference to FIG. 1B and FIG. 2A together first, an electronic device 100b in this embodiment is similar to the aforementioned electronic device 100a, but the difference therebetween is that in this embodiment, a cleaning module 120b further includes an auxiliary device 140b. A nozzle 142b of the auxiliary device 140b is adjacent to the cover layer 114 of the display module 110, and the auxiliary device 140b may be, for example, the detection component 125 (FIG. 2B), a dust blowing device, or a vibration device (e.g., ultrasonic), which may assist in detecting, blowing dust, or vibrating the cover layer 114.

In detail, in the top view of FIG. 2A, the display module 110 has a first side 115 and a second side 117 opposite to each other, as well as a third side 118 and a fourth side 119 opposite to each other. The cleaning module 120b is adjacent to the first side 115 of the display module 110, and the cleaning module 120b includes a ventilation duct 122 and an air outlet 124 connected to the ventilation duct 122, where the air outlet 124 is adjacent to the cover layer 114. The cleaning module 120b may be an in-vehicle air conditioning system or an independent air conditioning system, but the disclosure is not limited thereto. In an embodiment, a controller 160 may be optionally disposed at the air outlet 124 to control the direction of air flow. In an embodiment, the cleaning module 120b includes an upper cover D1, where a horizontal height of a bottom portion B1 of the upper cover D1 is higher than that of the cover layer 114. In a cross-sectional view, an orthographic projection of a side wall W1 of the upper cover D1 on the cover layer 114 overlaps the cover layer 114, and the side wall W1 may be a plane or a non-plane. In an embodiment, an extension direction of the side wall W1 is different from an extension direction of the bottom portion B1 of the upper cover D1. Through the design of the upper cover D1, the effect of reducing dust suspension may be achieved during the cleaning process, so the discomfort of driving is lowered. In an embodiment, a material of the upper cover D1 may be, for example, plastic or metal, but the disclosure is not limited thereto. The cleaning module 120b also includes the detection component 125 for detecting the degree of dirt on the cover layer 114. In an embodiment, the electronic device 100b may also include a splitter 150 disposed between the display module 110 and the cleaning module 120b and used to disperse the airflow F, so that the airflow F may flow through the upper surface and a lower surface (i.e., both sides) of the display module 110. In an embodiment, the airflow F flowing through the heat dissipation plate may enhance the heat dissipation efficiency.

Further, the dust collection module 130b is adjacent to the second side 117 of the display module 110 to facilitate the concentration of dirt, and the dust collection module 130b may also include a dust collection space 134 connected to the opening 132. In an embodiment, the number of opening 132 may be one or more. In an embodiment, the dust collection space 134 is, for example, a dust collection box. Further, the dust collection module 130b of this embodiment may also include an air extraction component 136 configured within the dust collection space 134. In an embodiment, the air extraction component 136 is, for example, a fan extraction device. The dust collection module 130b of this embodiment may also include a filtering component 138 disposed within the dust collection space 134. In an embodiment, the filtering component 138 is, for example, a replaceable filter. Through the air extraction component 136, dirt may be guided to the filtering component 138 for dust filtration. In an embodiment, the dust collection module 130b may also include a detection component 135 used to detect the degree and type of dirt (such as dust) in the air. In an embodiment, the detection component 135 is the same as the detection component 125, and thus a detailed description is omitted herein. In an embodiment, the dust collection module 130b includes an upper cover D2, where a horizontal height of a bottom portion B2 of the upper cover D2 is higher than that of the cover layer 114. In an embodiment, an orthographic projection of a side wall W2 of the upper cover D2 on the cover layer 114 overlaps the cover layer 114. The side wall W2 may be a plane or a non-plane. In an embodiment, the side wall W2 includes a first portion W21 and a second portion W22, where an angle less than 180 degrees is provided between the first portion W21 and the second portion W22, making the side wall W2 non-planar. In an embodiment, the side wall W2 may also be a convex curved surface. Through the design of the upper cover D2, the effect of reducing dust suspension may be achieved during the cleaning process, so the discomfort of driving is lowered. In an embodiment, a material of the upper cover D2 includes but not limited to plastic or metal.

Next, with reference to FIG. 2A and FIG. 2B together, the cover layer 114 and the light-emitting unit 112 of this embodiment overlap each other in the normal direction N of the display module 110. The cover layer 114 may be fixed to the display apparatus A through the adhesive layer 113. In an embodiment, a distance between the light-emitting unit 112 and the cover layer 114 is, for example, between 0 and 10 cm, or between 0 and 0.1 cm. The measurement method is to measure in the normal direction N from the side of the cover layer 114 close to the light-emitting unit 112 to the upper surface of the light-emitting unit 112. In an embodiment, a ratio of a distance h3 between the light-emitting unit 112 and the cover layer 114 to a thickness h4 of the cover layer 114 is between 0 and 1000, meaning 0<h3/h4<1000. In an embodiment, the thickness of the cover layer 114 is, for example, between 0.1 mm and 1 mm. Further, in this embodiment, the substrate 111 of the display module 110 is parallel to the cover layer 114, where the display module 110 has the light-emitting region A1 and a non-light-emitting region A2. In an embodiment, the light-emitting region A1 may be considered as a display region, while the non-light-emitting region A2 may be considered as a non-display region, such as a peripheral region. In an embodiment, the display module 110 may also include a light-shielding layer SD disposed on the adhesive layer 113, located in the non-light-emitting region A2, and used to shield light or conceal peripheral circuit lines. In an embodiment, a ratio of an area of the image M (e.g., a virtual image) in FIG. 1A to an area of the light-emitting region A1 is, for example, between 0.7 and 1.5. In an embodiment, a ratio of an area of the cover layer 114 to the area of the light-emitting region A1 is, for example, between 1.0 and 1.3.

In brief, in this embodiment, the electronic device 100b includes the cleaning module 120b and the dust collection module 130b disposed on opposite sides of the display module 110. The air outlet 124 of the cleaning module 120b is adjacent to the cover layer 114 to blow out the airflow F to raise dust. The opening 132 of the dust collection module 130a sucks dust through the air extraction component 136 to draw fallen dust and dust blown up by the airflow F into the dust collection space 134 and filters (i.e., dust filtration) through the filtering component 138. Through this design, the non-contact cleaning module 120b may clean the dirt (such as dust, etc.) on the surface of the display module 110 and collect it into the dust collection module 130b, so that the impact of dirt on the display quality of the electronic device 100b may be reduced/avoided. Further, the cleaning module 120b of this embodiment may also include the auxiliary device 140b, which may assist in cleaning by detecting, blowing dust, or vibrating the cover layer 114. In addition, the dust collection module 130b of this embodiment also includes the detection component 135, which may detect the degree and type of dirt.

FIG. 2C is a schematic view of a dust collection module of an electronic device according to another embodiment of the disclosure. With reference to FIG. 2A and FIG. 2C together first, a dust collection module 130c in this embodiment is similar to the aforementioned dust collection module 130b, but the difference therebetween is that in this embodiment, a filtering component 138′ of the dust collection module 130c is, for example, a filtering bag, where the filtering component 138′ is disposed between the air extraction component 136 and an opening 132′. In an embodiment, the filtering component 138′ may be, for example, washable or replaceable.

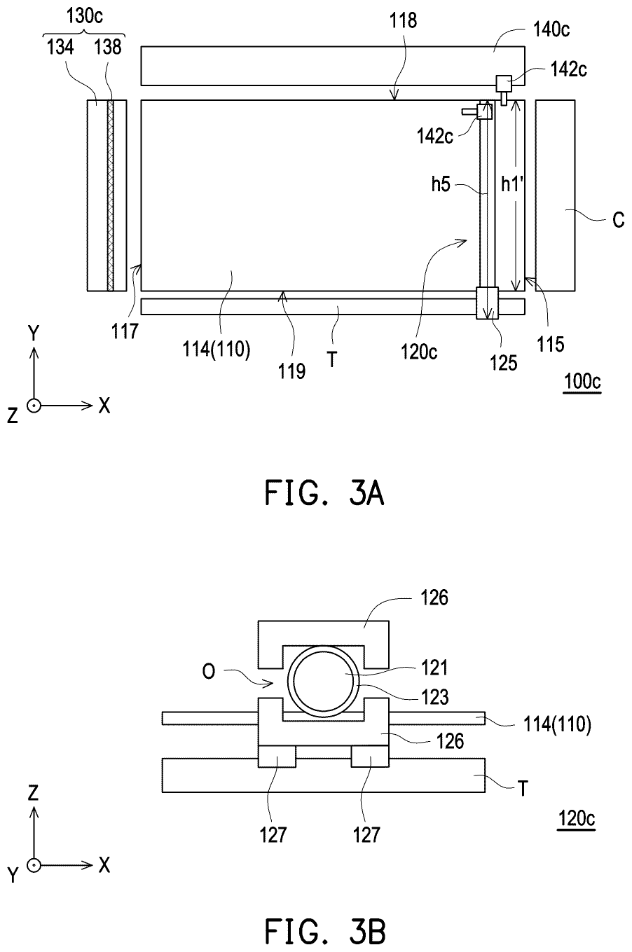

FIG. 3A is a schematic top view of an electronic device according to another embodiment of the disclosure. FIG. 3B is an enlarged schematic view of a cleaning module of the electronic device in FIG. 3A at another viewing angle. With reference to FIG. 2A and FIG. 3A together first, an electronic device 100c in this embodiment is similar to the aforementioned electronic device 100b, but the difference therebetween is that in this embodiment, a cleaning module 120c is, for example, a contact-type cleaning module.

In detail, with reference to FIG. 3A and FIG. 3B together, the dust collection module 130c is adjacent to the second side 117 of the display module 110, an auxiliary device 140c is adjacent to the third side 118 of the display module 110, and the cleaning module 120c is slidably set on a track T adjacent to the fourth side 119 of the display module 110 and extends above the cover layer 114. The cleaning module 120c may roll from the first side 115 adjacent to the display module 110 to the second side 117 to clean the surface of the cover layer 114. When the cleaning module 120c is not in use, it may be stored in a storage space C adjacent to the first side 115 of the display module 110 to prevent obstructing the image. In an embodiment, the storage space C and the display module 110 do not overlap in a Z direction. The storage space C and the track T are disposed on different sides of the display module 110.

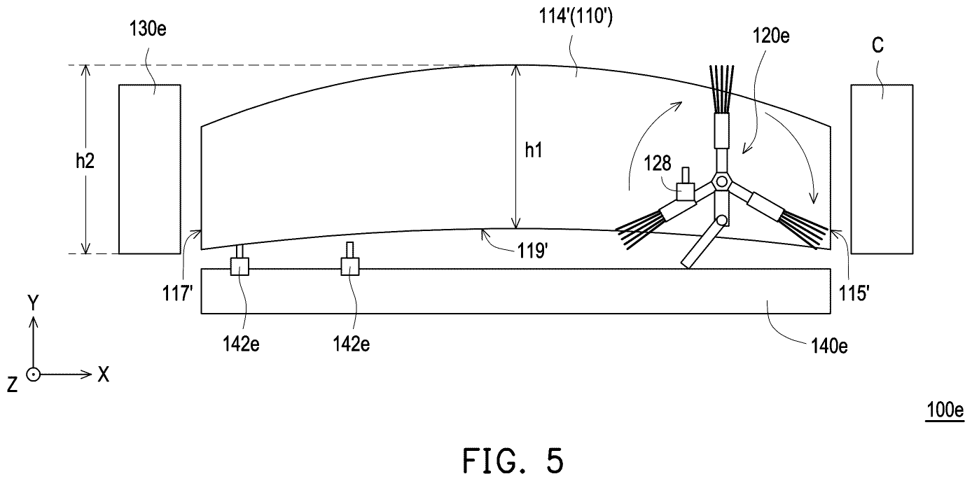

With reference to FIG. 3B again, in this embodiment, the cleaning module 120c includes a main body 121, a cleaning layer 123, a bracket 126, and a connector 127. The cleaning layer 123 covers an outer surface of the main body 121 and is fixed on the cover layer 114 through the bracket 126. The bracket 126 is connected to the track T through the connector 127, where the connector 127 is, for example, a one-way movable component. In an embodiment, the cleaning layer 123 is, for example, an adhesive layer or a wiping layer. In other words, the cleaning module 120c may be considered as a type of adhesive cleaning module. In an embodiment, the main body 121 of the cleaning module 120c and the cleaning layer 123 thereon may also be replaced by an air blowing device, which blows air towards the cover layer 114 through an opening O of the bracket 126. The dust collection module 130c of this embodiment includes the dust collection space 134 and the filtering component 138, where the dust collection module 130c may be replaceable or washable. The auxiliary device 140c is, for example, a cleaning agent storage device, a clean water storage device, or a detector, where a nozzle 142c may spray air, cleaning agent, or water, or conduct dirt detection. In an embodiment, the nozzle 142c may be arranged at the required position according to needs. In an embodiment, a display module 110′ (with reference to FIG. 5) may also be a curved display module, and the track T is a curved track, where the curvature of the track T follows the edge contour of the display module 110, so space usage is decreased. In the case of a curved display module, a length h5 of the cleaning module 120c is greater than a maximum length h1′ of the display module 110 in a Y direction. In an embodiment, a length of the cleaning module 120c is greater than a maximum length of the space occupied by the display module 110. In an embodiment, the cleaning module 120c may be extendable and retractable to accommodate the length of the display module 110 at different positions.

In brief, in the embodiments of the disclosure, the electronic device 100c uses the contact-type cleaning module 120c to clean the dirt (such as dust, etc.) on the surface of the display module 110 and collect it into the dust collection module 130c, so that the impact of dirt on the display quality of the electronic device 100c may be reduced/avoided. Further, the cleaning module 120c of this embodiment may also include the auxiliary device 140c, which may assist in cleaning by spraying air, cleaning agent, or water, or conducting dirt detection. In addition, when not in use, the cleaning module 120c of this embodiment may be hidden in the storage space C that does not obstruct the display surface, to prevent obstructing the image.

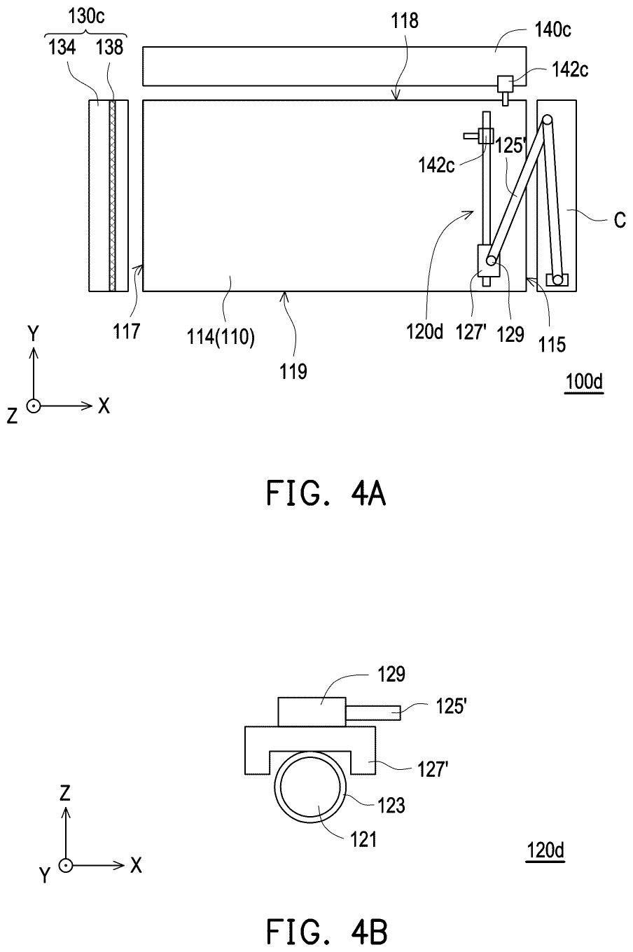

FIG. 4A is a schematic top view of an electronic device according to another embodiment of the disclosure. FIG. 4B is an enlarged schematic view of a cleaning module of the electronic device in FIG. 4A at another viewing angle. With reference to FIG. 3A and FIG. 4A together first, an electronic device 100d in this embodiment is similar to the aforementioned electronic device 100c, but the difference therebetween is that in this embodiment, a bracket 126′ of a cleaning module 120d may fold and extend in one direction (e.g., X-axis direction) of the display module 110.

In detail, with reference to FIG. 4A and FIG. 4B together, in this embodiment, the cleaning module 120d is composed of the main body 121, the cleaning layer 123, the bracket 126′, a connector 127′, and a pivot 129. The cleaning layer 123 covers the outer surface of the main body 121, the bracket 126′ is connected to the connector 127′ through the pivot 129. The main body 121 and the cleaning layer 123 thereon are fixed on the connector 127′, and the connector 127′ is, for example, a one-way movable component. In an embodiment, the cleaning module 120d may be considered as a type of adhesive cleaning module. In an embodiment, the main body 121 of the cleaning module 120d and the cleaning layer 123 thereon may also be replaced by an air suction device, which may suck up dirt on the surface of the cover layer 114. In an embodiment, the cleaning module 120d may be replaceable or washable. In an embodiment, when not in use, the cleaning module 120d may be stored in the storage space C to prevent obstructing the image.

FIG. 5 is a schematic top view of an electronic device according to another embodiment of the disclosure. With reference to FIG. 4A and FIG. 5 together first, an electronic device 100e in this embodiment is similar to the aforementioned electronic device 100d, but the difference therebetween is that in this embodiment, a cleaning module 120e is, for example, a rotating cleaning brush head, with a rotation range exceeding a length of a shortest side of the display module 110′.

In detail, in this embodiment, a maximum length of the display module 110′ is h1, while a maximum length of the space occupied by the display module 110′ is h2, where h1 is less than h2, i.e., h1<h2. The display module 110′ is a curved display module, where the storage space C is adjacent to a first side 115′ of the display module 110′, a dust collection module 130e is adjacent to a second side 117′ of the display module 110′, and an auxiliary device 140′ is adjacent to a fourth side 119′ of the display module 110′. The cleaning module 120e is connected to the auxiliary device 140′ and is positioned on a cover layer 114′, where the cleaning module 120e may rotate and move from being adjacent to the first side 115′ of the display module 110′ to being adjacent to the second side 117′ of the display module 110′ to clean a surface of the cover layer 114′. In an embodiment, the cleaning module 120e may also include a nozzle 128, which may perform air suction on the surface of the cover layer 114′. The auxiliary device 140e may be, for example, a detection component, a dust blowing device, a vibration device (e.g., ultrasonic), a liquid spraying device, or an air blowing device, with its nozzle 142e assisting in dust blowing, or spraying water, cleaning agent, or air onto the cover layer 114.

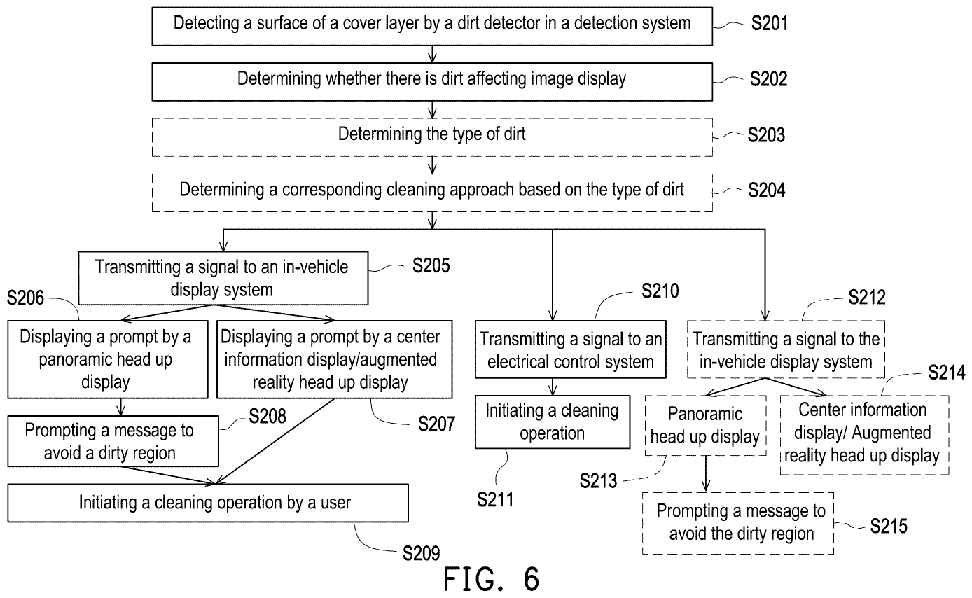

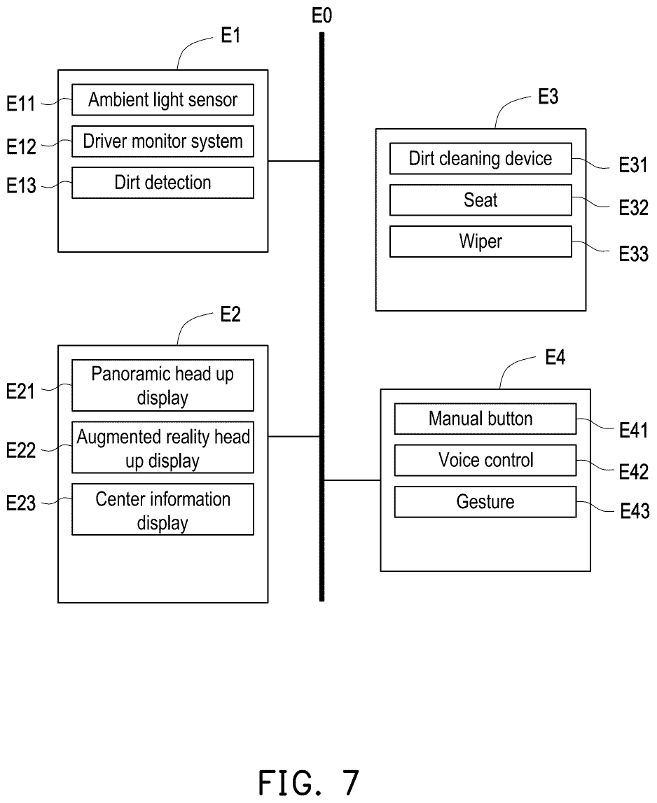

FIG. 6 is a flow chart of a cleaning procedure of an electronic device according to an embodiment of the disclosure. FIG. 7 is a system configuration view of the electronic device of FIG. 6. With reference to FIG. 7 first, in this embodiment, a controller area network (CAN or CAN bus) E0 may control four systems, namely a detection system E1, a display system E2, an electrical control system E3, and an operation system E4. Specifically, the detection system E1 includes at least an ambient light sensor (ALS) E11, a driver monitor system (DMS) E12, and dirt detection E13. The display system E2 includes at least a panoramic head up display (PHUD) E21, an augmented reality head up display (ARHUD) E22, and a center information display (CID) E23. The electrical control system E3 includes at least a dirt cleaning device E31, a seat E32, and a wiper E33. The operation system E4 includes at least a manual button E41, voice control E42, and a gesture E43.

Next, with reference to FIG. 6 and FIG. 7 together, for the manual cleaning procedure of the electronic device, first, in step S201, the surface of the cover layer is detected by a dirt detector in the detection system. Next, in step S202, it is determined whether there is dirt affecting image display. Next, step S203 may be optionally selected to determine the type of dirt. Next, step S204 may be optionally selected to determine a corresponding cleaning approach based on the type of dirt. Next, in step S205, a signal is transmitted to an in-vehicle display system. Next, regarding step S206 and/or step S207, in step S206, the panoramic head up display (PHUD) displays a prompt; and in step S207, the center information display (CID)/augmented reality head up display (ARHUD) displays a prompt. Next, in step S208, the panoramic head up display prompts a message to avoid a dirty region. Afterwards, in step S209, a user initiates a cleaning operation, meaning manual cleaning is performed after detection. During manual cleaning, a dirty state is obtained through the detection system E1, and the signal corresponding to the dirty state is transmitted to the display system E2 via the controller area network E0, where the display system E2 may display an operation interface or a prompt. The user may issue a control instruction through the operation system E4, and the signal corresponding to the control instruction is transmitted to the electrical control system E3 via the controller area network E0, where the electrical control system E3 may control the dirt cleaning device E31 to perform cleaning.

With reference to FIG. 6 and FIG. 7 together again, for the manual cleaning procedure of the electronic device, first, in step S201, the surface of the cover layer is detected by the dirt detector in the detection system. Next, in step S202, it is determined whether there is dirt affecting image display. Next, step S203 may be optionally selected to determine the type of dirt. Next, step S204 may be optionally selected to determine the corresponding cleaning approach based on the type of dirt. Next, in step S210, a signal is transmitted to the electrical control system. Finally, in step S211, a cleaning operation is initiated, where the cleaning operation may include the process of blowing airflow from the air outlet 124 of the cleaning module or contacting the cleaning layer 123 with the cover layer to remove dirt from the cover layer. Alternatively, in step S212, a signal is transmitted to the in-vehicle display system. Next, regarding step S213 and/or step S214, step S213 is for the panoramic head up display (PHUD), and step S214 is for the center information display (CID)/augmented reality head up display (ARHUD). Finally, in step S215, a message is prompted to avoid the dirty region. During automatic cleaning, the dirty state is obtained through the detection system E1, and the signal corresponding to the dirty state is transmitted to the electrical control system E3 via the controller area network E0, where the electrical control system E3 may control the dirt cleaning device E31 to perform cleaning. Optionally, the detection system E1 may transmit the signal corresponding to the dirty state to the display system E2 via the controller area network E0, where the display system E2 may display an operation interface (stop automatically) or a prompt. In another embodiment, the cleaning operation may be responsively executed when the vehicle starts, or it may be executed periodically, such as every 5 minutes. This period may be manually adjusted by the user or automatically adjusted by detecting the degree of dirt.

In view of the foregoing, in the embodiments of the disclosure, the electronic device includes the cleaning module and the dust collection module disposed on opposite sides of the display module, where at least a portion of the cleaning module is adjacent to the cover layer, and the opening of the dust collection module is adjacent to the cover layer. Through such a design, the cleaning module may clean dirt (e.g., dust) on the surface of the display module and collect it in the dust collection module, so that the impact of dirt on the display quality of the electronic device may be reduced/avoided.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. An electronic device installed on a vehicle with a windshield, comprising:
a display module, comprising:
a light-emitting unit adapted to emit a light beam; and
a cover layer disposed on the light-emitting unit and overlapping the light-emitting unit, wherein the windshield is opposite to the display module, and the light beam penetrates the cover layer and is imaged on the windshield; and
a cleaning module and a dust collection module disposed on two opposite sides of the display module, wherein at least one portion of the cleaning module is adjacent to the cover layer, the dust collection module has an opening, and the opening is adjacent to the cover layer.

2. The electronic device installed on the vehicle with the windshield according to claim 1, wherein the display module further comprises a substrate, the substrate and the cover layer are parallel to each other, and the display module has a light-emitting region and a non-light-emitting region.

3. The electronic device installed on the vehicle with the windshield according to claim 2, wherein image comprises a virtual image, and a ratio of an area of the virtual image to an area of the light-emitting region is between 0.7 and 1.5.

4. The electronic device installed on the vehicle with the windshield according to claim 2, wherein a ratio of an area of the cover layer to an area of the light-emitting region is between 1.0 and 1.3.

5. The electronic device installed on the vehicle with the windshield according to claim 2, wherein the display module further comprises a heat dissipation plate disposed below the substrate.

6. The electronic device installed on the vehicle with the windshield according to claim 1, wherein the cleaning module comprises a detection component.

7. The electronic device installed on the vehicle with the windshield according to claim 1, wherein the cleaning module comprises a ventilation duct and an air outlet connected to the ventilation duct, and the air outlet is adjacent to the cover layer.

8. The electronic device installed on the vehicle with the windshield according to claim 7, further comprising a controller disposed at the air outlet of the ventilation duct.

9. The electronic device installed on the vehicle with the windshield according to claim 1, wherein the dust collection module comprises a dust collection space, and the dust collection space is connected to the opening.

10. The electronic device installed on the vehicle with the windshield according to claim 1, wherein the dust collection module comprises an air extraction component.

11. The electronic device installed on the vehicle with the windshield according to claim 1, wherein the dust collection module comprises a filtering component.

12. The electronic device installed on the vehicle with the windshield according to claim 1, wherein the cleaning module comprises an air blowing device.

13. The electronic device installed on the vehicle with the windshield according to claim 12, wherein an air outlet of the cleaning module is opposite to the opening of the dust collection module.

14. The electronic device installed on the vehicle with the windshield according to claim 1, further comprising an auxiliary device, wherein a nozzle of the auxiliary device is adjacent to the cover layer of the display module.

15. The electronic device installed on the vehicle with the windshield according to claim 14, wherein the auxiliary device comprises a detection component, a dust blowing device, or a vibration device.

16. The electronic device installed on the vehicle with the windshield according to claim 1, wherein the cleaning module comprises an upper cover, and a horizontal height of a bottom portion of the upper cover is higher than that of the cover layer.

17. The electronic device installed on the vehicle with the windshield according to claim 16, wherein an orthographic projection of the side wall of the upper cover on the cover layer overlaps the cover layer.

18. The electronic device installed on the vehicle with the windshield according to claim 17, wherein an extension direction of the side wall is different from an extension direction of the bottom portion of the upper cover.

19. The electronic device installed on the vehicle with the windshield according to claim 1, further comprising a splitter disposed between the display module and the cleaning module.

20. The electronic device installed on the vehicle with the windshield according to claim 1, wherein a ratio of a distance between the light-emitting unit and the cover layer to a thickness of the cover layer is between 0 and 1000.
